(19) United States
(12) Patent Application Publication
(10) Pub. No.: US 2026/0176898 A1
(43) Pub. Date: Jun. 25, 2026

(54) STRIKER FOR DOOR LATCH

(71) Applicant: MITSUI KINZOKU ACT CORPORATION, Yokohama-shi (JP)

(72) Inventors: Hyunsuk SONG, Yokohama-shi (JP); Kouichi TSUMURAYA, Yokohama-shi (JP); Yusuke FUKASAWA, Yokohama-shi (JP); Yozo OGINO, Yokohama-shi (JP); Masayuki MOCHIZUKI, Yokohama-shi (JP); Kotaro MARUYAMA, Yokohama-shi (JP)

(21) Appl. No.: 19/322,225

(22) Filed: Sep. 8, 2025

(30) Foreign Application Priority Data
Sep. 10, 2024 (JP) 2024-155402

(51) Int. Cl. E05B 85/04

(52) U.S. Cl. CPC E05B 85/045

(57) ABSTRACT

The present disclosure relates to a striker for door latch comprising a base plate, and a rod,
wherein the base plate has leg fixing holes through which legs of the rod are inserted and fixed,
wherein the legs of the rod are inserted from a front side of the leg fixing holes and the portions protruding from a back side of the leg fixing holes are cold swaged, as a result, swage portions larger than the inner diameter of the leg fixing holes are formed on the back side of the base plate, further, flange portions larger than the inner diameter of the leg fixing holes and larger than an outer diameter of the legs are formed at a part of the legs on the front side of the base plate, the swage portions and the flange portions sandwich the base plate.

### CROSS-REFERENCE TO RELATED APPLICATIONS

This application claims benefit of the benefit of previously filed JP Application No. 2024-155402 which was filed on Sep. 10, 2024, which is incorporated herein by reference in its entirety.

### FIELD OF THE INVENTION

The present invention relates to a striker for door latch for holding a door in a closed position by engaging with a door latch provided on an automobile door, in particular, relates to the striker for door latch, which is expected to reduce CO₂ emissions by reducing power consumption through the formation of swage portions and flange portions on legs of a rod at a time during the manufacturing stage, as well as uses superior materials to improve strength and recyclability.

### BACKGROUND OF THE INVENTION

This section provides background information related to a striker for door latch and is not necessarily prior art to the striker for door latch of the present disclosure.

Conventionally, as a striker device that engages with a latch device to keep a door closed, there is known a striker device manufactured by inserting end portions of a rod into a base plate and cold swaging them, as disclosed in JP2935812B2 and CN114144562A. However, these products require a flange portion to be processed in advance, which were challenges not only in terms of manufacturing cost but also in terms of reducing power consumption and CO2 emissions, in other words, Sustainable Development Goals (SDGs).

The importance of promoting activities such as reducing power consumption and improving recycling is recognized in terms of environmental considerations and Sustainable Development Goals (SDGs).

The Sustainable Development Goals are international goals aimed at achieving a sustainable and better world by 2030, as set out in the “2030 Agenda for Sustainable Development” adopted at the United Nations Summit. The SDGs consist of 17 goals, and reducing power consumption is an effort that will lead to achieving Goal 7 (Energy), which aims to “Make energy clean and available to all.” In addition, improving recycling is an effort that will lead to achieving Goal 12 (Sustainable production and consumption) “Ensure sustainable production and consumption patterns.” Furthermore, with regard to Goal 13 (Climate Change) “Take urgent action to combat climate change,” this initiative is considered to be an effort that will lead to achieving Goal, as it is expected that reducing power consumption will result in a reduction of CO₂ emissions.

### SUMMARY OF THE INVENTION

The present invention is a striker for door latch comprising a base plate fixed to a striker mounting surface, and a rod formed U-shape having a pair of legs engageable with the door latch and a bottom portion between the pair of legs,
wherein the base plate has leg fixing holes through which the legs of the rod are inserted and fixed, an inner diameter of the leg fixing holes is equal to or larger than an outer diameter of the legs,
wherein the legs of the rod are inserted from a front side of the leg fixing holes and the portions protruding from a back side of the leg fixing holes are cold swaged, as a result, swage portions larger than the inner diameter of the leg fixing holes are formed on the back side of the base plate, further, flange portions larger than the inner diameter of the leg fixing holes and larger than an outer diameter of the legs are formed at a part of the legs on the front side of the base plate, the swage portions and the flange portions sandwich the base plate,
wherein the legs have the flange portions and engagement portions that are engageable with the door latch, the engagement portions are located closer to the bottom portion than the flange portions.

According to the striker for door latch of the present invention, the rod can be fixed by sandwich the base plate with the swage portion and the flange portion formed after cold swaging, without the need to perform a process of providing a flange portion of the rod on the front side of the base plate in advance. This reduces power consumption, thereby reducing CO₂ emissions and costs. Therefore, with regard to Goal 13 (Climate Change), this can be considered an initiative that will lead to the achievement of the goal, as it is expected that reducing power consumption will result in a reduction in CO2 emissions.

### BRIEF DESCRIPTION OF THE DRAWINGS

FIG. 1 is a perspective view of one embodiment of a striker for door latch according to the present invention.

FIG. 2 is a front view of the striker for door latch of FIG. 1.

FIG. 3 is an assembly process diagram of the striker for door latch of FIG. 1.

FIG. 4 is an assembly process diagram for the case where leg fixing holes are straight holes in the striker for door latch according to the present invention.

FIG. 5 is an assembly process diagram for the case where the leg fixing holes are tapered holes in the striker for door latch according to the present invention.

FIG. 6 is a diagram showing dies held by legs on a front side of a base plate during cold swaging when the leg fixing holes are straight holes.

FIG. 7 is a diagram showing dies held by legs on a front side of a base plate during cold swaging when the leg fixing holes are tapered holes.

### EMBODIMENTS OF THE INVENTION

According to the present invention, the above problems are solved as follows.

The first invention is a striker for door latch comprising a base plate fixed to a striker mounting surface, and a rod formed U-shape having a pair of legs engageable with the door latch and a bottom portion between the pair of legs,
wherein the base plate has leg fixing holes through which the legs of the rod are inserted and fixed, an inner diameter of the leg fixing holes is equal to or larger than an outer diameter of the legs,
wherein the legs of the rod are inserted from a front side of the leg fixing holes and the portions protruding from a back side of the leg fixing holes are cold swaged, as a result, swage portions larger than the inner diameter of the leg fixing holes are formed on the back side of the base plate, further, flange portions larger than the inner diameter of the leg fixing holes and larger than an outer diameter of the legs are formed at a part of the legs on the front side of the base plate, the swage portions and the flange portions sandwich the base plate,
wherein the legs have the flange portions and engagement portions that are engageable with the door latch, the engagement portions are located closer to the bottom portion than the flange portions.

Since the engagement portions that engage with the door latch are secured on the legs of the rod, while the swage portions and flange portions that function to prevent the legs of the rod from slipping off the base plate can be formed at the same time, the number of manufacturing steps for the striker 1 can be reduced, thereby reducing costs.

The second invention is that, in the striker for door latch described above in (1), wherein the leg fixing holes of the base plate are formed as straight holes on the front side, and the leg tips of the rod are formed with the same diameter all the way to end portions.

Since there is no need to process the leg fixing holes and the legs, the number of manufacturing steps for the striker 1 can be reduced, leading to cost reduction. At the same time, by making the end portions of the legs straight, it is easier to secure a large crushing (swaging) allowance when swaging, and the rod can be firmly held to the base plate, leading to improved reliability.

The third invention is that, in the striker for door latch described above in (1), wherein the leg fixing holes of the base plate are formed as tapered holes on the front side, and the leg tips of the rod are formed with the same diameter all the way to the end portions.

By providing a taper to the leg fixing holes of the base plate, the rod can be easily guided into the leg fixing holes when setting it in the jig, improving workability. At the same time, when swaging, the legs on the front side undergo plastic deformation along the taper, allowing the rod to be held more firmly to the base plate, further improving reliability.

The fourth invention is that, in the striker for door latch described above in (2) or (3), wherein a curved portion is formed in the leg between the engagement portion and the flange portion.

By providing the curved portion, even if a load is generated such as the door latch pulls the striker, the load is dispersed and can be firmly supported.

The fifth invention is that, in the striker for door latch described above in (1), wherein the leg fixing hole has a sheared surface and a fractured surface formed by shearing the base plate,

wherein the thickness of the sheared surface in the thickness direction of the base plate is at least ½ the thickness of the base plate.

The thicker, i.e., longer, the sheared surface, the stronger the adhesion between the leg and the sheared surface. However, in order to lengthen the sheared surface, an expensive process such as fine blanking is required, and therefore this does not lead to cost reduction. The length of the sheared surface can be adjusted to achieve appropriate adhesion and lead to cost reduction.

The sixth invention is that, in the striker for door latch described above in (1), wherein when forming said swage portion and said flange portion on said leg by cold swaging, the die in contact with the front side of the base plate holds the engagement portion, and a space is provided inside the die on the front side of the base plate and near the leg continuing to the front side of the base plate.

By providing a die of the above shape, the swage portion and the flange portion that function to prevent the rod from slipping out of the base plate can be formed at once, so that the number of manufacturing steps for the striker 1 can be reduced, thereby lead to cost reduction.

The following is a description of one embodiment of the present invention with reference to the drawings. The present invention is not limited by the embodiments described below, but includes those that have been modified from the following embodiments as appropriate within the scope obvious to those skilled in the art.

In the description herein, in a base plate 2, an opposite side to a side facing a striker mounting surface D is a front side, and the side facing the striker mounting surface D is a back side (see FIG. 2).

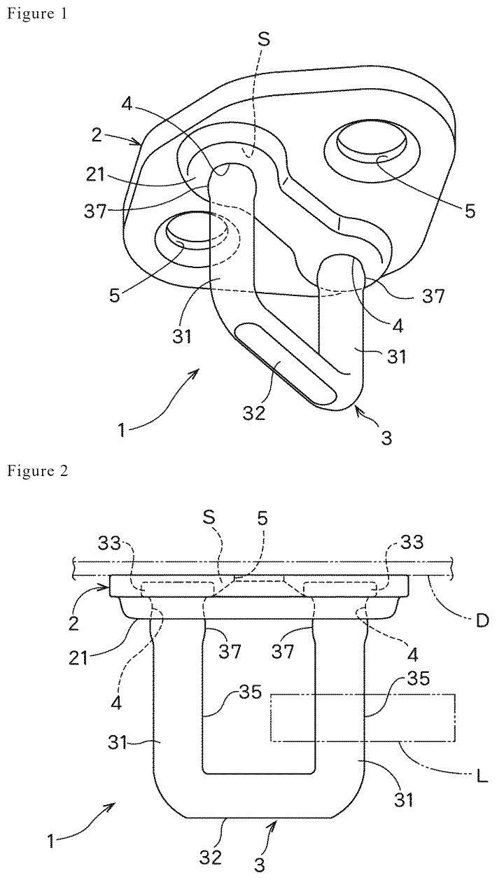

As shown in FIGS. 1 and 2, a striker for door latch 1 according to present embodiment is attached to the striker mounting surface D of an automobile body, and has a function of holding a door in a closed position by engaging with a door latch L attached to an automobile door. The striker 1 has the base plate 2 fixed to the striker mounting surface D of the body, and a U-shaped rod 3 having a pair of legs 31, 31 engageable with the door latch L and a bottom 32 connecting the pair of legs.

The base plate 2 is formed in a generally elliptical shape in a plan view. On the front side of the base plate 2 to which both legs 31 of the rod 3 are fixed, an upward-folding portion 21 is formed. Between this upward-folding portion 21 and the striker mounting surface D, a deformation-allowing space S is formed which opens continuously on a line connecting both ends of a pair of legs 31, 31 which are inserted into a pair of leg fixing holes 4, 4. When such the deformation-allowing space S is formed, in the case that a tensile load acts on the rod 3, the base plate 2 crushes the deformation-allowing space S and deforms toward the striker mounting surface D. As a result, the tensile load acting on the rod 3 is alleviated, making the rod 3 less likely to break.

The base plate 2 is fixed to a striker mounting surface D by inserting flat head screws or the like (not shown) through a pair of striker-mounting holes 5, 5. The rod 3 is cold swaged by inserting the ends of a pair of legs 31, 31 of the rod 3 into a pair of leg fixing holes 4, 4 provided in the base plate 2. In this manner, a pair of swage portions 33, 33 are formed on the back side of the base plate, and a pair of flange portions 37, 37 are formed on the front side of the base plate, so that the rod 3 is fixed by sandwiching the base plate 2 therebetween. According to the striker for door latch of the present invention, the rod 3 can be fixed to the base plate after cold swaging without the need for a process to previously provide the flange portions on the front side of the base plate 2 of the rod 3, which means that CO2 emissions can be reduced by reducing power consumption as well as costs can be reduced.

The material of base plate 2 is general steel material such as SS material (general structural rolled steel material) and SPH material (hot-rolled steel plate), while the material of rod 3 is high-strength steel material such as chrome molybdenum steel material (SCM material) and is boron steel.

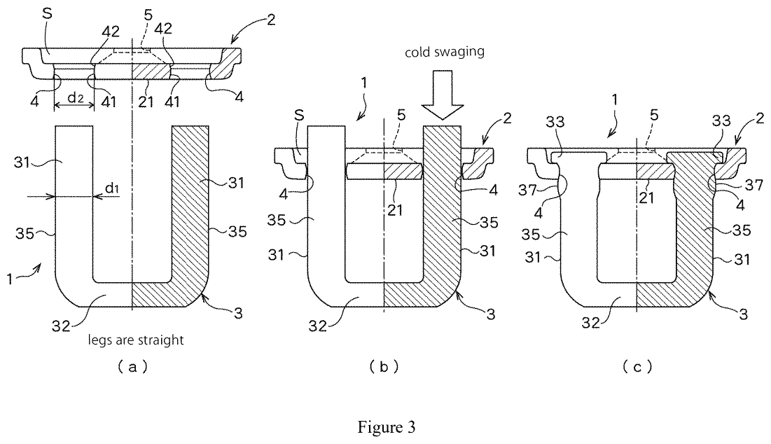

FIG. 3 shows an assembly process diagram of one embodiment of a striker for door latch according to the present invention. FIG. 3(a) shows the base plate 2 and the rod 3 that constitute the striker 1. As described above, the base plate 2 is composed of the leg fixing holes 4, the striker mounting holes 5, etc., and the rod 3 is composed of a pair of legs 31 and the bottom 32 connecting the pair of legs. The striker 1 is formed by inserting the pair of legs 31 of the rod 3 into a pair of leg fixing holes 4 provided in the base plate 2.

The pair of legs 31 of the rod 3 according to the present invention are composed of the same outer diameter d₁ throughout the entire legs up to the tips. Therefore, the inner diameter d₂ of the leg fixing holes 4 provided in the base plate 2, through which the legs 31 are inserted, is equal to or larger than the outer diameter d₁ of the legs. The leg fixing holes 4 are formed by a shearing process such as press working, and is composed of a sheared surface 41 and a fractured surface 42 which has a rougher surface than the sheared surface. The shearing process forms a taper at a predetermined angle on the fractured surface 42.

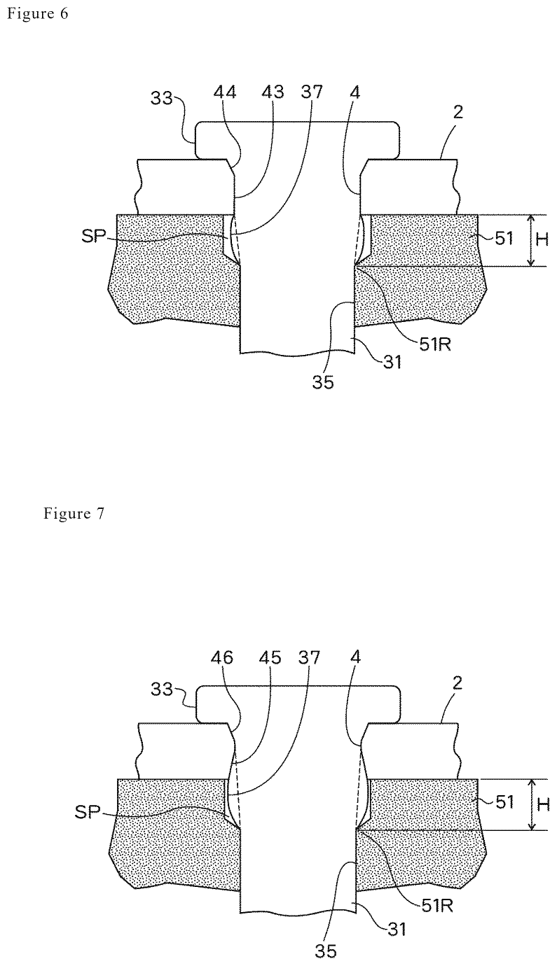

FIG. 3(c) shows a state in which the tips of the pair of legs 31 are inserted into the pair of leg fixing holes 4. In this state, as will be described later with reference to FIGS. 6 and 7, a die (metal mold) 51 that contacts a surface of the base plate 2 and holds an outer circumference of an engagement portion 35 of the leg 31 is attached to each of the pair of legs 31. By attaching the die 51, a flange portion 37 (see FIG. 3(c)) larger than the inner diameter d₂ of the leg fixing hole 4 can be provided on the front side of the base plate 2 due to plastic flow of the leg caused by cold swaging.

FIG. 3(c) shows the striker 1 after cold swaging has been performed in the state that the tips of the pair of legs 31 are inserted into the pair of leg fixing holes 4 as shown in FIG. 3(b). The swage portions 33 provided on the back side of the base plate 2 and the flange portions 37 provided on the front side of the base plate 2 sandwich the base plate 2, forming a striker 1 in which the base plate 2 and the rod 3 are tightly coupled. Each of the pairs of legs 31 has the engagement portion 35 that functions to hold the door in the closed position by engaging the door latch L.

Since the legs 31 of the rod 3 can secure the engagement portion 35 that engages with the door latch L while the swage portions and flange portions that function to prevent the legs 31 of the rod 3 from slipping out of the base plate 2 can be formed at once, the number of manufacturing steps for the striker 1 can be reduced and costs can be lowered.

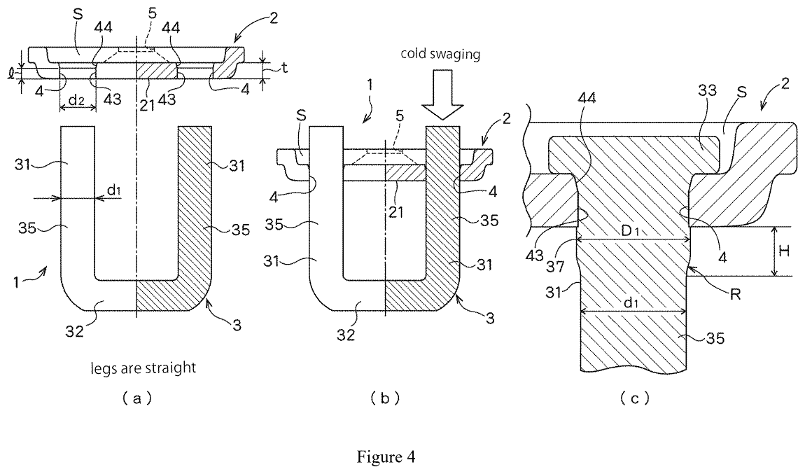

FIG. 4 shows an assembly process diagram for the case where the leg fixing holes 4 are straight holes in a striker for door latch 1 according to the present invention. As shown in FIG. 4(a), in a straight sheared surface 43 and a fractured surface 44 that are generated during shearing process, the leg fixing holes 4 are formed such that the thickness (length) l of the straight sheared surface 43 is at least ½ of the plate thickness t of the base plate 2. In addition, the straight sheared surface 43 is work-hardened by the shearing process. Although the longer straight sheared surface 43 provides better adhesion between the leg 31 and the straight sheared surface 43, it does not lead to cost reduction, since an expensive process such as fine blanking is required to lengthen the sheared surface. The length of the straight sheared surface 43 can be adjusted to achieve an appropriate adhesion, leading to cost reduction.

As shown in FIG. 4(a), the pair of legs 31 of the rod 3 according to the present invention are configured so that the entire legs are straight and have the same outer diameter d₁ up to the tip. Therefore, the inner diameter d₂ of the leg fixing holes 4 provided in the base plate 2, through which the legs 31 are inserted, is equal to or larger than the outer diameter d₁ of the legs.

FIG. 4(b) shows a state in which the tips of the pair of legs 31 are inserted into the pair of leg fixing holes 4. Since the tip of the leg portion 31 is straight, if cold swaging is performed in this state, it is easy to obtain a large crushing (swaging) allowance when swaging. By forming a large swage portion 33 on the back side of the base plate 2, the rod 3 can be firmly held to the base plate 2, leading to improved reliability.

As will be described later with reference to FIG. 6, in the state of FIG. 4(b), a die 51 that contacts a surface of the base plate 2 and holds an outer circumference of an engagement portion 35 of the leg 31 is attached to each of the pair of legs 31. By attaching the die 51, a flange portion 37 (see FIG. 4(c)) having an outer diameter D₁ larger than the inner diameter d₂ of the leg fixing hole 4 and larger than the outer diameter d₁ of the leg 31 can be provided on the front side of the base plate 2 due to plastic flow of the leg caused by cold swaging.

Furthermore, by attaching the die 51, as shown in FIG. 4(c), a smooth curved portion R having a constant radius of curvature is formed at the end portion on the engagement portion side of the flange portion 37 between the flange portion 37 and the engagement portion 35. By providing the curved portion R, even if a load is generated such that the door latch L pulls the engagement portion 35 of the striker 1, the load is distributed and the load on the engagement portion 35 can be firmly received.

As described above, by making the leg fixing hole 4 a straight hole, there is no need to process the leg fixing hole 4 and the leg 31, so that the number of manufacturing steps for the striker 1 can be reduced, and costs can be lowered.

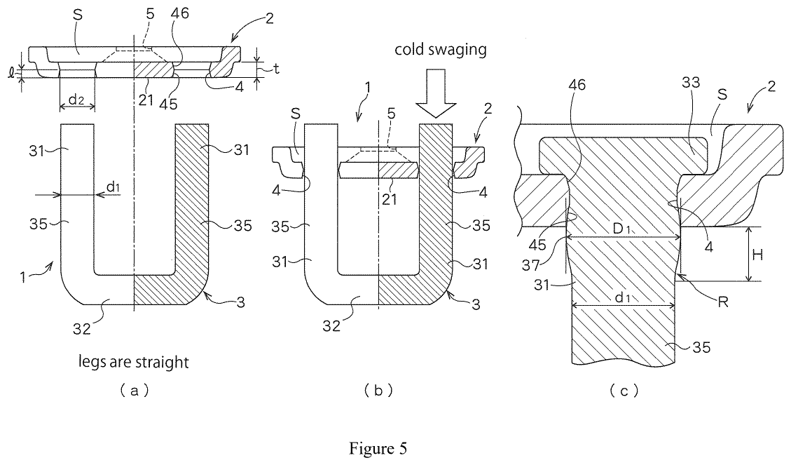

FIG. 5 shows an assembly process diagram for the case where a leg fixing holes 4 are tapered holes in a striker for door latch 1 according to the present invention. The leg fixing hole 4 is formed by a shearing process such as press working, and is composed of a sheared surface and a fractured surface which has a rougher surface than the sheared surface. As shown in FIG. 5(a), the sheared surface at the leg fixing holes 4 can be a tapered sheared surface 45 forming a tapered hole. In the tapered sheared surface 45 and the fracture surface 46, the tapered sheared surface 45 is formed such that the thickness 1 is at least ½ of the plate thickness t of the base plate 2.

The pair of legs 31 of the rod 3 according to the present invention are configured with the same straight outer diameter d₁ throughout the entire legs to the tips. Therefore, the inner diameter d₂ of the leg fixing holes 4 provided in the base plate 2 through which the legs 31 are inserted is configured with an inner diameter equal to or larger than the outer diameter d₁ of the legs. A taper of a predetermined angle is formed on the fractured surface 46 by the shearing process of the leg fixing hole 4. By providing a taper on the sheared surface of the leg fixing holes of the base plate, the legs 31 of the rod 3 can be easily guided into the leg fixing holes 4 when setting the rod 3 in the leg fixing holes 4, improving workability.

FIG. 5(b) shows a state in which the tips of the pair of legs 31 are inserted into the pair of leg fixing holes 4. Since the tip of the leg portion 31 is straight, if cold swaging is performed in this state, it is easy to obtain a large crushing (swaging) allowance when swaging. By forming a large swage portion 33 on the back side of the base plate 2, the rod 3 can be firmly held to the base plate 2, leading to improved reliability. Furthermore, when swaged, the legs on the front side are plastically deformed along to the taper of the tapered sheared surface 45, thereby making it possible to hold the rod 3 on the base plate 2 more firmly.

As will be described later with reference to FIG. 7, in the state shown in FIG. 5(b), a die 51 that contacts a surface of the base plate 2 and holds an outer circumference of an engagement portion 35 of the leg 31 is attached to each of the pair of legs 31. By attaching the die 51, a flange portion 37 (see FIG. 5(c)) having an outer diameter D₁ larger than the inner diameter d₂ of the leg fixing hole 4 and larger than the outer diameter d₁ of the leg 31 can be provided on the front side of the base plate 2 due to plastic flow of the leg caused by cold swaging.

Furthermore, by attaching the die 51, as shown in FIG. 5(c), a smooth curved portion R having a constant radius of curvature is formed at the end portion on the engagement portion side of the flange portion 37 between the flange portion 37 and the engagement portion 35. By providing the curved portion R, even if a load is generated such that the door latch L pulls the engagement portion 35 of the striker 1, the load is distributed and the load on the engagement portion 35 can be firmly received.

FIG. 6 shows a die 51 held by the engagement portion 35 of the leg 31 on the front side of the base plate during cold swaging when the sheared surface of the leg fixing hole is a straight hole. In the state shown in FIG. 4(b), a die 51 that contacts a surface of the base plate 2 and holds an outer circumference of the leg portion 31 is attached to each of the pair of legs 31. By attaching the die 51, a flange portion 37 having an outer diameter D₁ larger than the inner diameter d₂ of the leg fixing hole 4 and larger than the outer diameter d₁ of the leg 31 can be provided on the front side of the base plate 2 due to plastic flow of the leg caused by cold swaging.

As shown in FIG. 6, a space portion SP of the die 51 is provided on the front side of the base plate 2 and around the leg 31 in the vicinity of the front side of the base plate 2. When cold swaging is performed in the state shown in FIG. 4(b) with attaching the die 51, a tip portion of the leg 31 is fluidized by plastic deformation and flows into the space portion SP around the leg 31, resulting in the formation of a flange portion 37 having a large outer diameter D1. Furthermore, the die 51 is provided with a die corner 51R as a corner at a position distance H along the leg 31 from the front side of the base plate 2, that is, at the position where the space portion SP ends. The plastically flowed metal of the leg 31 flows into the space portion SP in the vicinity of this die corner 51R, forming a smooth curved portion R having a constant radius of curvature. By providing the curved portion R, even if a load is generated such that the door latch L pulls the engagement portion 35 of the striker 1, the load is distributed and the load on the engagement portion 35 can be firmly received.

Similar to FIG. 6, FIG. 7 shows a die held by the leg 31 on the front side of the base plate during cold swaging when the sheared surface of the leg fixing hole is a tapered hole. As shown in FIG. 7, a space portion SP of the die 51 is provided on the front side of the base plate 2 and around the leg 31 in the vicinity of the front side of the base plate 2. When cold swaging is performed in the state shown in FIG. 5(b) with attaching the die 51, a tip portion of the leg 31 is fluidized by plastic deformation and flows into the space portion SP around the leg 31, resulting in the formation of a flange portion 37 having a large outer diameter D1. When the leg fixing hole 4 has a tapered sheared surface 45, the adhesion of the plastically flowed metal of the leg 31 to the tapered sheared surface 45 and the fracture surface 46, as well as the flow into the space portion SP, have the following characteristics.

When the tip of the leg 31 is plastically deformed by cold swaging, the fractured surface 46, which is softer than the tapered sheared surface 45, is pressed and expanded in diameter by the swage portion 33 to form a more tapered shape, and the swage portion 33 and fractured surface 46 adhere to each other. This situation is the same as the fractured surface 44 in FIG. 4. On the other hand, at the tapered sheared surface 45, the leg 31 expands in diameter toward the front side of the base plate along the tapered sheared surface 45 due to plastic deformation of the leg 31, and is adhered to the tapered portion of the tapered sheared surface 45. Therefore, as shown in FIG. 7, the leg is firmly adhered to the tapered sheared surface 45 and the fractured surface 46. Furthermore, the flange portions in FIG. 6 and FIG. 7 are compared. The dashed lines drawn on the flange portions 37 in FIG. 6 and FIG. 7 are drawn so that the size of the flange portion can be compared. The flange portion shown in FIG. 7 occupies the area covering the tapered sheared surface 45 and is therefore larger than the flange portion shown in FIG. 6. Therefore, the tapered sheared surface shown in FIG. 7 can hold the rod 3 more firmly to the base plate 2 than the straight sheared surface 43 shown in FIG. 6.

The material of rod 3 can be boron steel instead of high-strength steel such as chrome molybdenum steel (SCM material). Generally, boron steel is a type of steel made by adding 0.008 wt % or more of boron and up to 0.3 wt % of chromium to carbon steel, and has the characteristics of excellent hardenability and higher strength than ordinary steel. Hardenability is improved with the addition of boron to carbon steel with lower carbon content, and machinability is improved with carbon steel with lower carbon content. Therefore, the annealing process can be omitted and the rod 3 can be machined.

By using boron steel as the material for the rod 3, the carbon content can be kept low, which provides excellent cold workability and allows for reduced power consumption and costs in terms of processing. Furthermore, the addition of chromium and molybdenum is kept low, leading to improved recycling as steel scrap. This will reduce the generation of slag containing chromium and molybdenum during the melting and refining of steel scrap, leading to contribution to achieving Goal 12 (Sustainable Consumption and Production) of the SDGs.

Therefore, this is leading to contribution to achieving the SDGs'goals of Goal 7 (Energy) to reduce power consumption and Goal 12 (Sustainable consumption and production). Furthermore, with regard to Goal 13 (Climate Change), this can be considered an initiative that will lead to the achievement of the goal, as it is expected that reducing power consumption will result in a reduction in CO2 emissions.

The striker for door latch according to the present invention can be applied to strikers for back doors, bonnets, trunk lids, etc. in addition to the side doors described above.

Although an embodiment of the present invention has been described above, the following various modifications, changes, and combinations can be made to the above embodiment without departing from the gist of the present invention.

For example, the shape of the base plate is formed in a generally elliptical shape in a plan view, but the shape of the base plate is not particularly limited. For example, the shape of the base plate may be generally circular or generally rectangular in a plan view.

For example, the base plate may be made of high-strength steel material in addition to general steel material depending on the vehicle strength requirements. By using high-strength steel, the sheared surface of the leg fixing hole is less likely to deform when the leg is cold swaging than when general steel material is used, so the hole diameter of the leg fixing hole is less likely to expand, which is advantageous in terms of strength.

What is claimed is:

1. A striker for door latch comprising a base plate fixed to a striker mounting surface, and a rod formed U-shape having a pair of legs engageable with the door latch and a bottom portion between the pair of legs,
wherein the base plate has leg fixing holes through which the legs of the rod are inserted and fixed, an inner diameter of the leg fixing holes is equal to or larger than an outer diameter of the legs,
wherein the legs of the rod are inserted from a front side of the leg fixing holes and the portions protruding from a back side of the leg fixing holes are cold swaged, as a result, swage portions larger than the inner diameter of the leg fixing holes are formed on the back side of the base plate, further, flange portions larger than the inner diameter of the leg fixing holes and larger than an outer diameter of the legs are formed at a part of the legs on the front side of the base plate, the swage portions and the flange portions sandwich the base plate,
wherein the legs have the flange portions and engagement portions that engage with the door latch, the engagement portions are located closer to the bottom portion than the flange portions.

2. The striker for door latch according to claim 1, wherein the leg fixing holes of the base plate are formed as straight holes, and the leg tips of the rod are formed with the same diameter all the way to end portions.

3. The striker for door latch according to claim 1, wherein the leg fixing holes of the base plate are formed as tapered holes on the front side, and the leg tips of the rod are formed with the same diameter all the way to the end portions.

4. The striker for door latch according to claim 2, wherein a curved portion is formed in the leg between the engagement portion and the flange portion.

5. The striker for door latch according to claim 3, wherein a curved portion is formed in the leg between the engagement portion and the flange portion.

6. The striker for door latch according to claim 1, wherein the leg fixing hole has a sheared surface and a fractured surface formed by shearing the base plate,
wherein the thickness of the sheared surface in the thickness direction of the base plate is at least ½ the thickness of the base plate.

7. The striker for door latch according to claim 1, wherein when forming said swage portion and said flange portion on said leg by cold swaging, the die in contact with the front side of the base plate holds the engagement portion, and a space is provided inside the die on the front side of the base plate and near the leg continuing to the front side of the base plate.
